(19) United States
(12) Patent Application Publication
(10) Pub. No.: US 2004/0004551 A1
(43) Pub. Date: Jan. 8, 2004

(54) Fluid management system

(76) Inventor: Gay M. Early, Jupiter, FL (US)

Correspondence Address: J. Rodman Steele, Jr., Suite 400, 222 Lakeview Ave., West Palm Beach, FL, 33401, US

(21) Appl. No.: 10/190,926

(22) Filed: Jul. 8, 2002

(51) Int. Cl. G08B 21/00

(52) U.S. Cl. 340/603; 340/539.1

(57) ABSTRACT

A fluid management system having a central communications station and at least one probe having at least one sensor in which the sensor measures a level of a fluid and detects contaminants. A fluid management system having a central communications station and at least one substantially buoyant probe having at least one sensor for measuring a level of a fluid in which at least a first portion of the probe rests above a surface of the fluid and at least a second portion of the probe rests below the surface of the fluid. A fluid management system having a central communications station and at least one probe having a sensor for detecting contaminants in a fluid. In all three management systems, the probe contains circuitry for transmitting data collected by the sensor to the central communications station.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Technical Field

The present invention relates generally to fluid management systems, and more particularly to fluid management systems for measuring fluid levels and detecting contaminants in fluids.

2. Description of the Related Art

Currently, there are many ways to store fluids. Many fluids are stored in above-ground or in-ground tanks until the fluid stored inside is accessed for transfer. A major challenge for any industry in which fluids are stored in these tanks is the accurate control or management of these fluids. Such a challenge is of particular concern to the petroleum industry.

Petroleum-based products such as fuel oil or gasoline are typically stored in storage tanks ranging anywhere from roughly 8,000 gallons (small in-ground tanks) to about 250,000 gallons (large above-ground tanks). To maintain an accurate inventory of any stored petroleum-based products and to monitor the tanks for leaks, it is desirable to measure the level of fluid in these tanks and to convert this reading to a volume on a consistent basis. Unfortunately, an inaccurate measurement can produce inventory levels that are far from the exact amount being stored. For example, if the measured level of a fluid stored in a 10,000 gallon tank is just one inch off, the reading generated from this measurement would deviate from the true volume of fluid by nearly 83 gallons. If this error occurs with other tanks at a single site, these erroneous measurements can produce inventory levels that are sometimes hundreds or even thousands of gallons off the true amount being stored. The inability to maintain precise readings can inhibit the capacity to detect theft or leaks in a storage tank.

Contamination detection is also a significant aspect of fluid management. For example, many tanks that store gasoline have a small amount of water at the bottom of the tank. This layer of water can produce inaccurate readings in the amount of gasoline stored in the tank, and this factor must be considered when performing fluid measurements. In addition, the fluid stored in a tank can also be considered a contaminant if such fluid leaks from the tank. As an example, some storage tanks may begin to leak over time and may contaminate surrounding bodies of water. Thus, when managing fluids, it is important not only to monitor the volume of fluid in a storage tank, it is also crucial to detect contaminants.

These two aspects of fluid management, generating accurate inventory levels and detecting contaminants, can be quite expensive, however, because generally two separate systems are required to perform both functions. That is, the owner of a storage tank must install a system for providing tank measurements and a separate system for detecting contaminants. Even if such a configuration is put together, there must be a way of efficiently communicating the data collected by the systems. Thus, what is needed is a fluid management system capable of providing accurate volumetric readings of stored fluids and detecting contaminants that may affect these readings as well as pollute surrounding areas. Additionally, this system must be able to collect and communicate data in an orderly and efficient fashion.

### SUMMARY OF THE INVENTION

The present invention concerns a fluid management system. The system comprises a central communications station and at least one probe having at least one sensor in which the sensor measures a level of a fluid and detects contaminants. In addition, the probe contains circuitry for transmitting data collected by the sensor to the central communications station. In one arrangement, the probe can have a plurality of the sensors in which at least one of the sensors can measure the level of the fluid and another sensor can detect contaminants in the fluid. In addition, at least one of the sensors can measure the level of a first fluid and another sensor can detect contaminants in a second fluid. The probe can be interchangeable between the first fluid and the second fluid. In another arrangement, the probe can be substantially buoyant such that at least a first portion of said probe can rest above a surface of the fluid and at least a second portion of the probe can rest below the surface of the fluid. Also, if the probe has a plurality of sensors, at least one of the sensors can be a temperature sensor for measuring the temperature of the fluid.

In one aspect, the sensor used to measure the level of the fluid and to detect contaminants can be an ultrasound sensor, and the sensor used to measure the level of the fluid can also be a laser sensor. The probe can also contain circuitry for wirelessly transmitting data collected by the sensor to the central communications station, and the probe can have a unique identifier for enabling the central communications station to identify the probe. The system can also include a monitoring station and a communications device. In this embodiment, the central communications station can transmit the data received from the probe to the monitoring station, and the monitoring station can store the data and can transmit the data to the communications device.

In one arrangement, the fluid can be a petroleum-based fluid, and at least one of the contaminants can be water. The fluid can be stored in a tank having a fill pipe, and the probe can be inserted in the tank through the fill pipe. Further, the sensor can measure the level of the fluid and can detect contaminants and the probe can transmit the data in accordance with a predetermined interval. At least a portion of the contaminants can be in the fluid or proximate to the fluid.

The present invention also concerns a fluid management system having a central communications station and at least one substantially buoyant probe having at least one sensor for measuring a level of a fluid in which at least a first portion of the probe rests above a surface of the fluid, and at least a second portion of the probe rests below the surface of the fluid. The probe contains circuitry for wirelessly transmitting data collected by the sensor to the central communications station. In this embodiment, the sensor used to measure the level of the fluid can be an ultrasound sensor. In addition, the probe can have a unique identifier for enabling the central communications station to identify the probe.

This particular system can also include a monitoring station and a communications device. The central communications station can transmit the data received from the probe to the monitoring station, and the monitoring station can store the data and can transmit the data to the communications device. In addition, the fluid can be a petroleum-based fluid in which the fluid can be stored in a tank having a fill pipe, and the probe can be inserted in the tank through the fill pipe. The sensor can measure the level of the fluid and the probe can transmit the data in accordance with a predetermined interval.

The invention also concerns a fluid management probe having at least one sensor in which the sensor measures a level of a fluid and detects contaminants and circuitry for transmitting data collected by the sensor to a central communications station. In one arrangement, the probe can have a plurality of sensors in which at least one of the sensors can measure the level of the fluid and another sensor can detect contaminants in the fluid. Also, at least one of the sensors can measure the level of a first fluid and another sensor can detect contaminants in a second fluid. The fluid management probe can be interchangeable between the first fluid and the second fluid. Moreover, the fluid management probe can be substantially buoyant such that at least a first portion of the probe can rest above a surface of the fluid and at least a second portion of the probe can rest below the surface of the fluid.

In one aspect, the fluid management probe can further include a calibration ring in which the calibration ring and the sensor can be used to determine the density of the fluid and to generate a calibration cycle time for the fluid. The fluid management probe can also include a housing in which the fluid can be in a tank, and the fluid management probe is stored in the tank; the calibration ring can be attached to a base of the housing such that the calibration ring can prevent the base of the housing from striking a bottom of the tank when the fluid is removed from the tank. In another aspect, the fluid management probe can have a plurality of the sensors and can further include a plurality of corresponding control modules and at least one receptacle for detachably receiving the sensors and the control modules. If the fluid management probe has a plurality of the sensors, at least one of the sensors can be a temperature sensor for measuring the temperature of the fluid.

In another aspect of the fluid management probe, the sensor used to measure the level of the fluid and to detect contaminants can be an ultrasound sensor, and the sensor used to measure the level of the fluid can also be a laser sensor. Additionally, the probe can contain circuitry for wirelessly transmitting data collected by the sensor to a central communications station, and the probe can have a unique identifier for enabling the central communications station to identify the probe. The fluid can be a petroleum-based fluid, and at least one of the contaminants can be water. In another arrangement, the sensor can measure the level of the fluid and can detect contaminants and the probe can transmit the data in accordance with a predetermined interval. At least a portion of the contaminants can be in the fluid or proximate to the fluid.

The sensor that detects contaminants can be a materials sensor, and at least one of the contaminants can be a chemical or a biological contaminant. The fluid can be water, and the contaminant can be, for example, salt phosphorous, petroleum-based fluids or Escherichia coli. In addition, the fluid can be part of a natural body of water.

The invention also concerns a fluid management probe having a housing and at least one sensor contained within the housing for measuring a level of a fluid. The fluid management probe is substantially buoyant such that at least a first portion of the probe rests above a surface of the fluid and at least a second portion of the probe rests below the surface of the fluid. The fluid management probe also contains circuitry for wirelessly transmitting data collected by the sensor to a central communications station. In one embodiment, the sensor used to measure the level of the fluid can be an ultrasound sensor. The probe can also have a unique identifier for enabling a central communications station to identify the probe.

In one aspect of this invention, the fluid can be a petroleum-based fluid in which the fluid can be stored in a tank having a fill pipe, and the probe can be inserted in the tank through the fill pipe. Also, the sensor can measure the level of the fluid and the probe can transmit the data in accordance with a predetermined interval.

The invention also concerns a fluid management system having a central communications station and at least one probe having a sensor for detecting contaminants in a fluid in which the probe has circuitry for wirelessly transmitting data collected from the sensor to the central communications station. In this system, the probe can includes a unique identifier such that the unique identifier can be transmitted with the data to the central communications station thereby permitting the station to locate the probe. This unique identifier can be an identifier associated with a global positioning system.

In one arrangement, the sensor can be a materials sensor in which the fluid can be water and at least one of the contaminants can be phosphorous. In addition, the fluid can be part of a natural body of water. This system can also include a monitoring station and a communications device. The central communications station can transmit the data received from the probe to the monitoring station, and the monitoring station can store the data and can transmit the data to the communications device. The sensor can detect contaminants and the probe can wirelessly transmits the data in accordance with a predetermined interval.

The invention also concerns a method for managing at least one fluid. The method includes the steps of providing at least one probe having at least one sensor, measuring a level of the fluid with the sensor, detecting contaminants with the sensor and transmitting from the probe data collected by the sensor to a central communications station. In one arrangement, the probe can have a plurality of sensors, and the method can further include the steps of measuring a level of the fluid with at least one sensor and detecting contaminants in the fluid with another sensor. In addition the method can include the steps of measuring the level of a first fluid with at least one of the sensors and detecting contaminants in a second fluid with another sensor in which the probe can be interchangeable between the first fluid and the second fluid. The probe can also be substantially buoyant, and the method can further include the step of positioning the probe such that at least a first portion of the probe can rest above a surface of the fluid and at least a second portion of the probe can rest below the surface of the fluid.

In another aspect of the method, the transmitting step can further include wirelessly transmitting from the probe data collected by the sensor to the central communications station. The method can also further include the steps of providing a monitoring station and a communications device, transmitting from the central communications station the data received from the probe to the monitoring station, storing the data in the monitoring station and transmitting the data from the monitoring station to the communications device. In another arrangement, the fluid can be stored in a tank having a fill pipe, and the method can further include the step of inserting the probe in the tank through the fill pipe. In addition, the method can further include the step of performing the measuring, detecting and transmitting steps in accordance with a predetermined interval. The method can also include the steps of assigning a unique identifier to the probe and transmitting the unique identifier during the transmitting step

The invention also concerns a method of managing a fluid including the steps of providing at least one probe having at least one sensor, measuring a level of the fluid with the sensor, positioning the probe such that at least a portion of the probe rests above a surface of the fluid and at least a portion of the probe rests below the surface of the fluid and wirelessly transmitting from the probe data collected by the sensor to a central communications station. In one arrangement, the method can further include the steps of providing a monitoring station and a communications device, transmitting from the central communications station the data received from the probe to the monitoring station, storing the data in the monitoring station and transmitting the data from the monitoring station to the communications device.

In another aspect of this method, the fluid can be stored in a tank having a fill pipe, and the method can further include the step of inserting the probe in the tank through the fill pipe. The method can also include the step of performing the measuring and transmitting steps in accordance with a predetermined interval. In another embodiment, this method can further include the steps of assigning a unique identifier to the probe and transmitting the unique identifier during the transmitting step.

The invention also concerns another method of managing a fluid in which the method includes the steps of providing at least one probe having a sensor, detecting contaminants in the fluid with the sensor and wirelessly transmitting from the probe data collected by the sensor to a central communications center. This method further includes the steps of assigning a unique identifier to the probe and transmitting the unique identifier during the wirelessly transmitting step. In another arrangement, the method can further include the steps of providing a monitoring station and a communications device, transmitting from the central communications station the data received from the probe to the monitoring station, storing the data in the monitoring station and transmitting the data from the monitoring station to the communications device. Also, the method can include the step of performing the detecting and transmitting steps in accordance with a predetermined interval.

### BRIEF DESCRIPTION OF THE DRAWINGS

FIG. 1 illustrates a fluid management system in accordance with the inventive arrangements.

FIG. 2 illustrates another fluid management system in accordance with the inventive arrangements.

FIG. 3 illustrates a fluid management probe in accordance with the inventive arrangements.

FIG. 4 illustrates the fluid management probe of FIG. 3 positioned inside a tank in accordance with the inventive arrangements.

### DESCRIPTION OF THE PREFERRED EMBODIMENTS

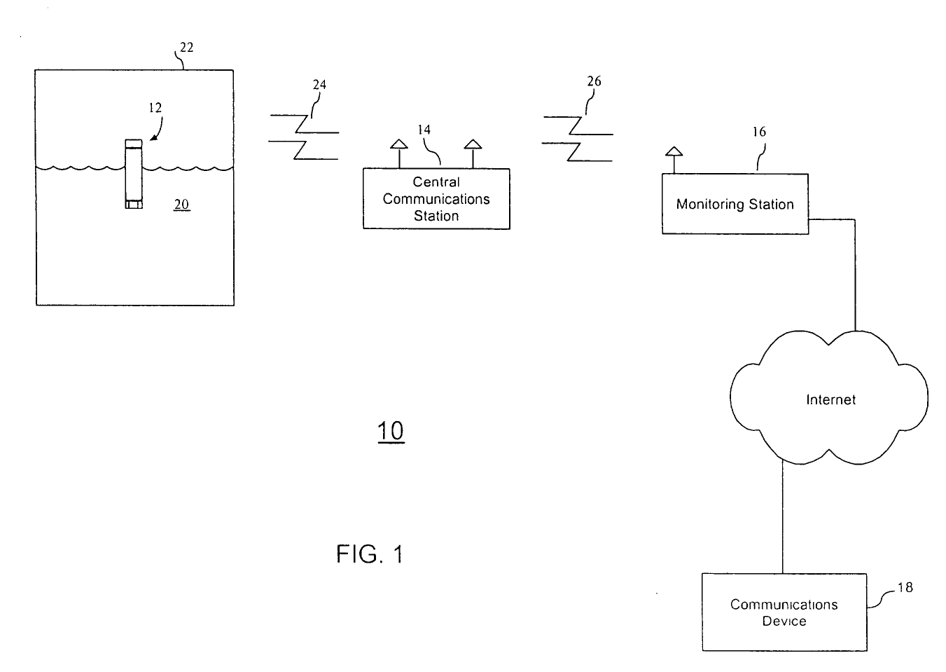

Referring to FIG. 1, a fluid management system 10 in accordance with the inventive arrangements is illustrated. The system 10 includes one or more fluid management probes 12 and one or more central communications stations 14. The system 10 can also include one or more monitoring stations 16 and one or more communications devices 18. The fluid management probe 12 can be used to perform a wide variety of tasks. In system 10, the fluid management probe 12 can be used to manage a fluid 20 in a tank 22. As an example, the fluid management probe 12 can determine the depth of a particular fluid 22 in the tank 22. A more detailed explanation of this process, in addition to other fluid management processes, will be provided later. The system 10 can include any suitable number of fluid management probes 12 and any suitable number of tanks 22. In addition and as will be explained later, the fluid management probe 12 is not limited to managing a single fluid 20, as the probe 12 can manage any suitable number of fluids 20. For purposes of the invention, a fluid can be any substance having particles that can easily move and can change their relative position without a separation of the mass. Suitable examples include water, gasoline and diesel fuel.

The data collected by the fluid management probe 12 can be transmitted to the central communications station 14. This data can be transmitted to the central communications station over a communications link 24. In one arrangement, the communications link 24 can be any suitable radio frequency (RF) link for transmitting data. For purposes of the invention, an RF link can be any frequency suitable for propagating an electromagnetic wave through any suitable medium. Examples of suitable wireless transmission standards for the communications link 24 can include 802.11a, 802.11b, Bluetooth or those standards commonly employed in mobile communications devices such as Global System for Mobile communications (GSM). Additionally, the data collected by the fluid management probe 12 can be transmitted to the central communications station 14 over a standard hard-wired communications link. As will be explained below, the fluid management probe 12 can collect and transmit data in accordance with a predetermined interval.

The central communications station 14 can receive data collected by any suitable number of fluid management probes 12. As an example, a fluid management probe 12 can be positioned in each of a plurality of tanks 22, and each of the fluid management probes 12 can transmit collected data to the central communications station 14. Such a configuration is economical in that a single communications center 14 can receive data concerning a large number of tanks 22 It is understood, however, that the invention is not so limited, as the system 10, if it is desired, can include a central communications station 14 for each fluid management probe 12. In one embodiment, the central communications station 14 can include its own internal power source (not shown) such as a battery. Integrating an independent power source in the central communications station 14 can ensure proper operation of the system 10 in the event of a power failure in the surrounding area. Nevertheless, the central communications station 14 can also receive its power from a standard power grid.

The central communications station 14 can transfer any data that it has received from the fluid management probe 12 to the monitoring station 16. In one arrangement, the central communications station 14 can immediately transmit to the monitoring station 16 the data the station 14 receives from the fluid management probe 12. Alternatively, the central communications station 14 can temporarily store the data it receives from the fluid management probe 12 and can then transmit the data to the monitoring station 16 at predetermined intervals. In either embodiment, the data can be transferred over a wireless or hard-wired communications link 26. If the communications link 26 is wireless, any suitable RF transmission standard can be employed including those standards that can be used to transmit data over large distances such as those used in mobile communications devices.

The monitoring station 16 can process the data it receives from the central communications station 14 to create reports on the data collected by the fluid management probe 12. As an example, the monitoring station 16 can contain information relating to the fluid 20 being managed such as volumetric equations of the tank 22 storing the fluid 20. If the fluid management probe 12 measures the level of the fluid 20 in the tank 22, once this data is transferred to the monitoring station 16, the station 16 can determine the amount of fluid 20 currently being stored in the tank 22. As will become apparent throughout the application, this process is merely one example of the type of data that can be collected by the fluid management probe 12 and processed by the monitoring station 16.

The monitoring station 16 can also include a number of databases (not shown) and can store the information that it receives from the central communications station 14 in these databases once the information is processed. In one arrangement, the monitoring station 16 can be wired to the Internet, which can permit a user to access the stored information through the communications device 18 such as a computer. Thus, the data collected by the fluid management probe 12 can be continuously updated and accessed at any time. It must be noted, however, that the information stored by the monitoring station 16 can be accessed through any other suitable medium, as the accessing medium is not limited to the Internet.

In another arrangement, the system 10 can be configured to provide user-initiated fluid management. For instance, a user can access the monitoring station 16 through the communications device 18 and can order the system 10 to perform one or more aspects of fluid management. As an example, a user can request information concerning the amount of fluid 20 in the tank 22. The monitoring station 16 can signal the central communications station 14 through the communications link 26, and the central communications station 14 can signal the fluid management probe 12 through the communications link 24. The fluid management probe 12 can then measure the level of the fluid 20 in the tank 22, and the data can be transmitted back to the monitoring station 16 and processed in accordance with the discussion above. As a result, fluid management can occur on an automated or user-initiated basis.

As noted earlier, the system 10 can include any suitable number of fluid management probes 12. To keep track of these fluid management probes 12, each probe 12 can be assigned a unique identifier to enable the central communications station 14 and the monitoring station 16 to identify each probe 12. Such a feature can permit the system 10 to monitor any number of storage devices in an organized fashion. A more detailed explanation of this feature will be provided below.

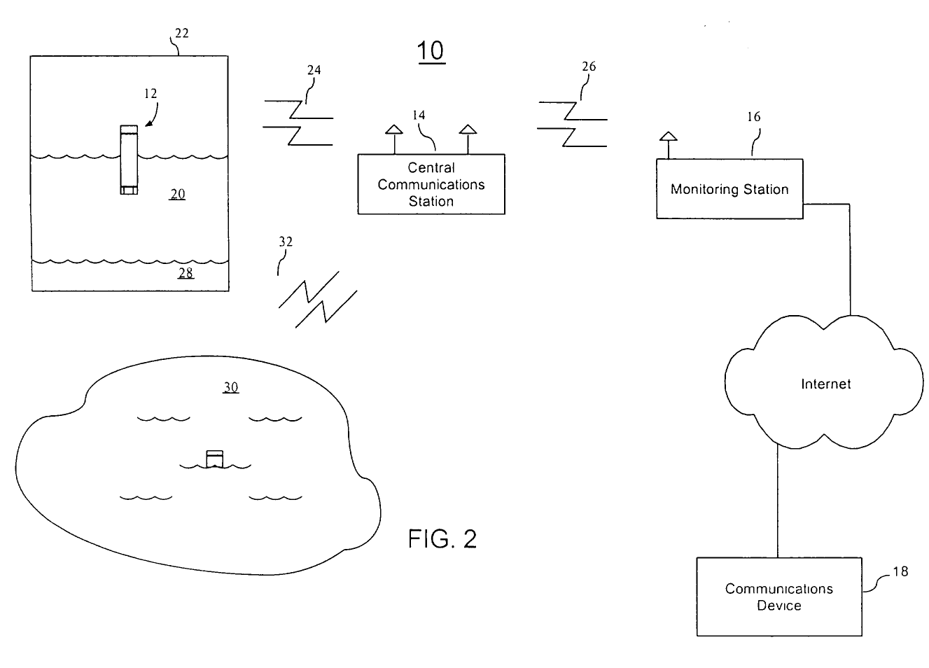

Referring to FIG. 2, another aspect of fluid management in accordance with the inventive arrangements will be presented. As shown in FIG. 2, the system 10 can include each of the components discussed in relation to FIG. 1. In this arrangement, the system 10 can include one or more fluid management probes 12 positioned in a second fluid 30. The fluid management probe 12 in the second fluid 30 can, for example, be used to detect contaminants in the second fluid 30. These contaminants can be chemical or biological contaminants. As it is a versatile device, the fluid management probe 12 can be used to manage the fluid 20 stored in the tank and can also be used to manage the second fluid 30 such that the fluid management probe 12 is interchangeable between the fluid 20 and the second fluid 30. It is understood that the fluid management probe 12 is interchangeable between any suitable number of fluids.

If the fluid management probe 12 is monitoring the second fluid 30 for contaminants, the probe 12 can collect data relating to the contamination of the second fluid 30 and can transmit this data to the central communications station 14 over a communications link 32. Each fluid management probe 12 can also include a unique identifier for enabling the central communications station 14 and the monitoring station 16 to keep track of the probes 12 when placed in the second fluid 30. This communications link 32 can be a wireless or a hard-wired communications link. In the case of a wireless communications link 32, any suitable RF transmission standard can be used to relay data to the central communications station 14. Similar to the discussion relating to FIG. 1, the central communications station 14 can transmit the data concerning the second fluid 30 to the monitoring station 16 over the communications link 26, which can also be a hard-wired or wireless communications link. Also, any suitable number or type of communications devices 18 can be used to access the monitoring station 16.

The monitoring station 16 can be programmed to convert the data collected by the fluid management probe 12 and forwarded by the central communications station 14 into, for example, a contamination report showing the contaminants and a parts per million reading. Those of ordinary skill in the art will recognize that the monitoring station 16 can be programmed to generate any other suitable report for informing users of any potential contamination of the second fluid 30. Although the fluid 20 in the tank 22 can be considered a contaminant in the second fluid 30 if the fluid 20 were to infiltrate the second fluid 30, the fluid management probe 12 is not limited to merely detecting fluid 20 as a contaminant; the fluid management probe 12 can be used to detect any other contaminant in the second fluid 30.

As an example, the second fluid 30 can be water, and the fluid management probe 12 can be used to detect a chemical contaminant such as phosphorous in the second fluid 30. In this example, the second fluid 30 can be part of a natural body of water. Detecting phosphorous in natural bodies of water is important, as this contaminant, typically caused by agricultural runoff, is generally regarded as a significant water pollutant. Other contaminants that the fluid management probe 12 can be used to detect can include salt (which can pollute fresh water systems), petroleum-based fluids, and bacteria such as Escherichia coli (E. coli), particularly the strain E. coli O157:H7.

Additionally, if the second fluid 30 is part of a natural body of water, the fluid management probe 12 can be constructed such that it is unencumbered by any couplings or attachments. Alternatively, the fluid management probe 12 can be anchored to any suitable manmade device or article of nature. In either arrangement, the fluid management probe 12 can be positioned entirely below the surface of the water or positioned so that at least a portion of the fluid management probe 12 rests above the surface of the water. For purposes of the invention, a natural body of water can include man-made lakes or canals. In any event, the invention is not limited in this regard, as the second fluid 30 can be any other fluid suitable for monitoring.

As also shown, the tank 22 may contain a contaminant 28. The fluid management probe 12 can also detect the contaminant 28 in the tank 22. Although only one contaminant 28 is shown, the fluid management probe 12 can detect more than one contaminant 28 in the tank 22 The contaminant 28 can be a contaminant that is in the fluid 20, i.e., it combines or mixes with the fluid, or it can be a contaminant that is proximate to or adjacent to the fluid 20, as shown in FIG. 2. This layering phenomena is caused by the combination of fluids of different densities in a stable environment. It is important to detect contaminants in either arrangement, as it is desirable to maintain the purity of the fluid 20 as well as to provide accurate volumetric measurements of the fluid 20.

As an example, the contaminant 28 in tank 22 can be water, and the fluid management probe 12 readily detects the presence of water. In one example, if the fluid 20 in tank 22 is a petroleum-based fluid and the contaminant 28 is water, the water will in time rest at the bottom of the tank 22, a condition that threatens the accuracy of any volumetric measurement. The fluid management probe 12 can measure the depth or level of the petroleum-based fluid and the level of the water, and the data is eventually transmitted to the monitoring station 16. The monitoring, station 16 can be programmed to generate the amount of water measured in the tank 22 thereby increasing the accuracy of the system 10.

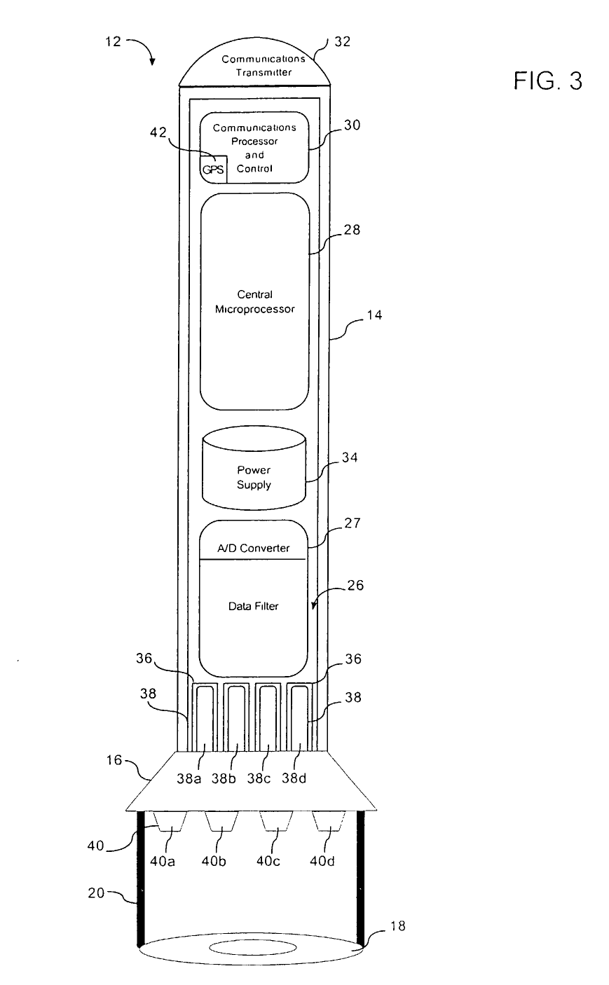

Referring to FIG. 3, an example of a fluid management probe 12 in accordance with the inventive arrangements is illustrated. The fluid management probe 12 can include a housing 14, a base 16 attached to the housing 14 and a calibration ring 18. One or more supports 20 can be used to attach the calibration ring 18 to the base 16. In one arrangement, the fluid management probe 12 can have a data filter 26, a central microprocessor 28, a communications processor and control 30 and a communications transmitter 32. The data filter 26 can include an analog-to-digital (A/D) converter 27.

To provide power, the fluid management probe 12 can include a power supply 34. As an example, the power supply can be a lithium battery to ensure a reliable, long-lasting supply of power. Those of ordinary skill in the art, however, will appreciate that any other suitable power supply can be integrated into the fluid management probe 12.

The housing 14 can be constructed of any durable material capable of withstanding the corrosive effects of fluids. In one arrangement, the material used to construct the housing 14 can be lightweight to enable the fluid management probe 12 to float in the fluid being monitored such that the probe 12 is above the bottom of a tank (when holding a fluid) or the bottom of a natural body of water. It is understood that the invention is not so limited, as the fluid management probe 12 can be constructed of a material heavy enough to force the probe 12 to rest at the bottom of any fluid from which it is collecting data. The housing 14 can also be waterproof. As shown in FIG. 3, the data filter 26, the A/D converter 27, the central microprocessor 28, the communications processor and control 30 and the power supply 34 can be placed inside the housing 14. Placing these components in the housing 14 can ensure proper operation of the fluid management probe 12 in virtually any environment. The invention, however, is not limited to this particular configuration, as any other suitable design for the fluid management probe 12 can be used.

The fluid management probe 12 can also include one or more receptacles 36 for receiving one or more control modules 38. In addition, the fluid management probe 12 can have one or more sensors 40, which can be electrically coupled to a corresponding control module 38. The control module 38 can control the operation of a sensor 40 to which it is coupled and can transfer the data collected by the sensor 40 to the data filter 26. In one arrangement, the sensor 40 and a corresponding control module 38 can be an integrated unit such that the receptacle 36 can detachably receive a sensor 40 and a corresponding control module 38.

Although not limited to the configuration illustrated in FIG. 3, attaching the calibration ring 18 to the base 16 of the housing 14 (through one or more supports 20) can help prevent the sensors 40 of the fluid management probe 12 from being damaged. For example, if the fluid management probe 12 is monitoring a fluid in a tank, the calibration ring 18 can prevent the sensors 40 from striking the bottom of the tank if the fluid is drained from the tank. It is understood, however, that the fluid management probe 12 can include any other suitable structure for protecting the sensors 40.

In one particular embodiment, the fluid management probe 12 can include a temperature sensor 40a, an ultrasonic sensor 40b, a laser sensor 40c and a materials sensor 40d. The temperature sensor 40a can be coupled to a corresponding temperature control module 38a, the ultrasonic sensor 40b can be coupled to a corresponding ultrasonic control module 38b and the laser sensor 40c can be coupled to a corresponding laser control module 38c. Additionally, the materials sensor 40d can be coupled to a corresponding materials control module 38d.

In another arrangement, the receptacles 36 can detachably receive any of the sensors 40 and any corresponding control module 38. As a result, the fluid management probe 12 can be equipped with any suitable combination of the sensors 40a, 40b, 40c and 40d. For example, if desired, the fluid management probe 12 can be equipped merely with the temperature sensor 40a (coupled to the temperature control module 38a) and the ultrasound sensor 40b (coupled to the ultrasonic control module 38b). Continuing with this example, the laser sensor 40c and the materials sensor 40d could be implemented into the fluid management probe 12 at a later time. It is understood that the invention is not limited to this particular example, as any other combination of the sensors 40a, 40b, 40c and 40d can be integrated into the fluid management probe 12. Moreover, the invention is not limited to the four sensors 40a, 40b, 40c and 40d described above, as the fluid management probe 12 can be equipped with any other suitable sensor.

The central microprocessor 28 can control the operation of the control modules 38a, 38b, 38c and 38d thereby controlling the operation of the sensors 40a, 40b, 40c and 40d. In addition, the central microprocessor 28 can control the operation of the data filter 26, the A/D converter 27, the communications processor and control 30 and the communications transmitter 32. The fluid management probe 12 can also contain control and data interfaces (not shown) for permitting the microprocessor to control the operation of these components.

The temperature sensor 40a can determine the temperature of a fluid being managed. The temperature sensor 40a can be any suitable device for determining the temperature of a fluid. To initiate the temperature taking process, the temperature control module 38a can signal the temperature sensor 40a to determine the temperature of the fluid being monitored. The data collected by the temperature sensor 40a can be forwarded to the temperature control module 38a, which can transmit the temperature data to the central microprocessor 28. As the temperature of a fluid increases, the volume of the fluid increases as well. Conversely, as the temperature of a fluid decreases, the volume of the fluid will also decrease. In response to such fluctuations, some industries have promulgated standards to provide for more uniform measurements. For instance, the petroleum industry mandates that volumetric measurements be normalized to sixty degrees Fahrenheit. If, for example, a petroleum-based fluid is monitored, determining the temperature of the fluid can enable the volumetric measurements of the fluid to be normalized to the industry standard.

The ultrasound sensor 40b can be used to help determine the depth of a fluid being monitored. This depth reading can be entered into one or more volumetric equations relating to a tank holding the fluid to determine the amount of fluid in the tank. For purposes of the invention, a volumetric equation can be any mathematical equation corresponding to a particular tank or other holding device that considers the dimensions of the tank or holding device and uses the depth of a fluid to calculate the amount of fluid in the tank. In one arrangement, the ultrasound sensor 40b can be an ultrasound transceiver that can broadcast ultrasonic waves through the fluid being monitored and can receive the reflections of these waves once they bounce off an interface such as the bottom of a tank. An interface can be considered any boundary formed by two substances in which there is a difference in acoustic impedance between the two substances. Another example of an interface beyond the bottom of a tank and a fluid can include an interface created by a fluid having a relatively low specific density resting on top of a fluid having a relatively high specific density.

Because ultrasonic waves will reflect from virtually any interface, the ultrasound sensor 40b can also be used to detect contaminants in a fluid. For example, a layer of water may be present at the bottom of many gasoline storage tanks and is proximate to the fluid intended to be stored in a tank. Water can enter a storage tank during refueling procedures, through condensation or breaches in the tank and during certain prior art inventory measuring processes. This layer of water is considered a contaminant and can lead to inaccurate volumetric measurements.

The ultrasound sensor 40b, however, can detect the interface that exists between the petroleum-based fluid and the water. As such, the fluid management probe 12 can ignore the layer of water when determining the amount of fluid in the tank and can limit. Its volumetric calculations to the amount of petroleum-based fluid in the tank. In another arrangement, the depth of the layer of water can be measured based on the detection of the fluid/water interface and any subsequent interfaces such as between the layer of water and the bottom of the tank, which can permit the fluid management probe 12 to determine the amount of the contaminant in the tank. A more detailed explanation of this process will be presented below. In addition, it is understood that water is not the only contaminant that the ultrasound sensor 40b can detect, as other contaminants that generate ultrasonic interfaces can be detected as well. The ultrasound sensor 40b can also detect an interface between two or more fluids that are intended to be stored together, which can permit the fluid management probe 12 to determine the volume of several fluids in a tank.

Similar to the temperature control module 40a, the ultrasound control module 40b can control the ultrasound sensor 40b by signaling the ultrasound sensor 40b to begin broadcasting ultrasonic waves through the fluid. The ultrasound sensor 40b can receive the reflections of these ultrasonic waves, convert them into electrical signals and direct them to the ultrasound control module 38b, where the ultrasonic wave reflection signals can be preliminarily processed Subsequently, the ultrasound control module 38b can forward these signals to the data filter 26 for further processing.

The laser sensor 40c can also be used to determine the depth of a fluid being monitored Like the process of using ultrasound described above, the depth reading can be entered into one or more volumetric equations relating to a tank holding the fluid to determine the amount of fluid in the tank. The laser sensor 40c can be a laser transceiver that can emit a laser pulse through the fluid and can receive the reflections of the laser pulse once they rebound from an interface such as the interface created between the fluid and the bottom of a tank. The laser sensor 40c is also capable of directing a laser pulse towards the calibration ring 18 and capturing the reflection of the laser pulse from the calibration ring 18.

The laser control module 38c can signal the laser sensor 40c to emit and receive laser pulses. The laser sensor 40c can convert the laser reflections that it receives into electrical signals and can transmit these signals to the laser control module 38c, which can preprocess the laser reflection signals before forwarding them to the data filter 26.

The materials sensor 40d can be used to perform materials analyses of any fluid being monitored. The materials sensor 40d can detect contaminants that are in or that dissolve into a fluid being monitored, which would not necessarily generate an interface that can be detected by the ultrasound sensor 40b. These contaminants can be either chemical or biological contaminants. As an example, the materials sensor 40d can detect the presence of bacteria in a petroleum-based fluid thereby providing a mechanism for informing individuals in charge of monitoring the inventory that the purity of a particular fluid being stored may have been jeopardized.

As another example and as noted earlier, the fluid being monitored by the fluid management probe 12 can be water, and the contaminant for which the materials sensor 40d is sensing can be phosphorous, salt, petroleum-based fluids and bacteria. Monitoring contaminant levels in water can quickly alert water management officials of an excessive pollution problem. Moreover, the type of contaminants to be detected are not limited to the above examples, as the materials sensor 40d can be designed to detect any other suitable contaminant. In fact, the materials sensor 40d is not limited to monitoring a fluid for a contaminant; the materials sensor 40d can also detect substances that are intended to be in the fluid.

The materials control module 38d can control the operation of the materials sensor 40d by signaling the materials sensor 40d to perform a materials analysis of the fluid being monitored. The signals generated by the materials sensor 40d can then be transmitted to the materials control module 38d, which can transmit these signals to the data filter 26.

The data filter 26 can receive signals from each of the control modules 38a, 38b, 38c and 38d. In one arrangement, the signals received from the temperature control module 38a, the laser control module 38c and the materials control module 38d can be transmitted to the A/D converter 27 in the data filter 26. The A/D converter 27 can convert these signals into digital signals and can forward them to the central microprocessor 28 for further processing.

Additionally, the data filter 26 can receive signals from the ultrasound control module 38b and can filter these signals. The signals that are allowed to pass through the data filter 26 can be digitally converted by the A/D converter 27 and then transmitted to the central microprocessor 28. The signals that the data filter 26 receives from the ultrasound control module 38b represent the ultrasonic wave reflections captured by the ultrasound sensor 40b As noted earlier, these reflections can be generated from interfaces created by several fluids or a fluid and a boundary such as the sides or bottom of a tank. Not all of these interface reflections, however, are useful in determining the amount of the fluid or fluids being monitored.

For example, the interface reflections created from a fluid in contact with the side of a tank and captured by the ultrasound sensor 40b are not important when determining the depth of the fluid or the presence of a contaminant or multiple fluids. Conversely, interface reflections such as those created from the interface between the fluid being monitored and a contaminant or the bottom of a tank are important for determining the volume of a fluid. Thus, It is desirable to filter unwanted interface reflection signals and to permit suitable interface reflection signals to be processed.

As known in the art, a microprocessor can be programmed to recognize and accept specific interface reflection signals produced by transmitting ultrasonic waves through a fluid and ultimately receiving the reflected waves. The microprocessor can be programmed to reject those interface reflection signals that it does not recognize and can even be programmed to reject certain interface reflection signals that it does recognize. Additionally, the microprocessor can be programmed to accept interface reflection signals that it recognizes and that are useful in calculating the volume of a fluid or detecting the presence of contaminants or multiple fluids

As is also known in the art, a particular interface will generate a substantially unique interface reflection signal when an ultrasonic wave bounces off the interface. As an example If gasoline is stored in a tank constructed of, for example, steel, the interface reflection signal created from the interface between the gasoline and the bottom of the tank is substantially unique such that it can be distinguished from other interface reflection signals produced by interfaces between the gasoline and another fluid or the sides of the tank. Thus, a microprocessor can be programmed to recognize certain interface reflection signals for one or more particular fluids stored in a particular tank.

As a result, the data filter 26 can be programmed to recognize numerous interface reflection signals and to accept and reject interface reflection signals when the ultrasound sensor 40b transmits an ultrasonic wave through a fluid that the fluid management probe 12 is monitoring. In one arrangement, the data filter 26 can be programmed to recognize an interface reflection signal created from an interface between a specific fluid and the bottom of a specific tank and an interface reflection signal generated by the interface between two particular fluids. Also, the data filter 26 can be programmed to recognize an interface reflection signal created from an ultrasonic wave reflecting off the calibration ring 18 of the fluid management probe 12 It is understood, however, that the invention is not limited to these examples, as the data filter 26 can be programmed to recognize any other suitable interface reflection signal.

Once the ultrasound control module 38b forwards an interface reflection signal to the data filter 26, the data filter 26 can determine whether it recognizes the signal. If the signal is an unrecognized signal, the data filter 26 can ignore the signal and can prevent the signal from undergoing any further processing. If the data filter 26 recognizes the interface reflection signal, the data filter 26 can determine whether it will accept or reject the signal, as the data filter 26 can be programmed to accept or reject recognized signals for a particular measuring cycle. For instance, if the fluid management probe 12 has already undergone an initial calibration stage—a process that will be explained below—the interface reflection signals generated from the ultrasonic waves reflecting off the calibration ring 18 can be rejected, as they are no longer important for determining the depth of a fluid once the fluid management probe 12 is calibrated.

An accepted interface reflection signal can be a signal that is useful for a particular function being performed by the fluid management probe 12. As an example, if the fluid management probe 12 is measuring the volume of a fluid, then the interface reflection signal from the interface between the fluid and the bottom of a storage tank can be an accepted signal. The A/D converter 27 can convert the accepted signals into digital signals, and the data filter 26 can transfer these digital signals to the central microprocessor 28 for further processing. The data filter 26 can also signal the central microprocessor 28 as to which interface reflection signals it is transferring to the central microprocessor 28.

Once the central microprocessor 28 receives the digital signals (data that has been collected by the sensors 40a, 40b, 40c and 40d), the central microprocessor 28 can be programmed to process these signals by performing certain calculations, several of which will be described below. The central microprocessor 28 can direct these processed signals containing information about the fluid being monitored to the communications processor and control 30. The communications processor and control 30 can process the signals received from the central microprocessor 28 for purposes of transmitting the signals—via the communications transmitter 32—to the central communications station 14, as described earlier in relation to FIGS. 1 and 2 In one particular embodiment, the communications processor and control 30 and the communications transmitter 32 can be constructed to enable the fluid management probe 12 to transmit data over a wireless communications link. Of course, the invention is not limited in this regard, as the communications processor and control 30 and the communications transmitter 32 can be configured to transmit data over a hard-wired communications link.

Referring to FIGS. 1 and 2, any number of fluid management probes 12 can be used with the system 10. As a result, it may be helpful to provide a way for the central communications station 14 to identify a data transmission from a particular fluid management probe 12 or to locate the probe 12. As a result, one or more of the fluid management probes 12 in use with a system 10 can include a unique identifier, which can be encoded into their data transmissions to the central communications station 14.

Referring back to FIG. 3, the central microprocessor 28 can be programmed to store one or more unique identifiers such as a predetermined number of bits that can identify the fluid management probe 12 and the tank in which the fluid management probe 12 is currently located, if the probe 12 is in such a tank. Another example of a unique identifier that the central microprocessor 28 can store is a set of bits identifying the entity that owns or is in control of the fluid being monitored by the fluid management probe 12.

The central microprocessor 28 can insert the unique identifier into the signals containing the data collected by the sensors 40a, 40b, 40c or 40d, signals that the central microprocessor 28 can transmit to the communications processor and control 30. Referring once again to FIGS. 1 and 2, in one arrangement, the central communications station 14 can be designed to accept only those signals associated with a particular unique identifier. For example, if the unique identifier identifies the entity in control of the fluids being monitored, the central communications station 14 can be programmed to accept only those signals that include a unique identifier associated with this particular entity. It is understood, however, that the invention is not limited in this regard, as the central communications station 14 can selectively accept signals based on any other unique identifier. In addition, the central communications station 14 is not limited to selectively accepting signals transmitted from a fluid management probe 12, as the central communications station 14 can be designed to accept any signal from any fluid management probe 12.

Referring to FIG. 3, in another arrangement, the communications processor and control 30 can include a global positioning system (GPS) tracker 42. As those of ordinary skill in the art will appreciate, the GPS tracker 42 can provide information as to the geographical location of the fluid management probe 12. For purposes of the invention, this information can be considered a unique identifier and can be integrated into the data signals that are being transmitted from the probe 12 to the central communications station 14 and to the monitoring station 16 of FIGS. 1 and 2. The GPS tracker 42 and the geographical information that it provides can be helpful in locating the fluid management probe 12, which may be necessary, for example, if the probe 12 is placed in a body of water.

As noted earlier, the central microprocessor 28 can control the operation of the control modules 38a, 38b, 38c and 38d, thereby controlling the operation of the sensors 40a, 40b, 40c and 40d. In addition, the central microprocessor 28 can control the operation of the data filter 26, the A/D converter 27, the communications processor and control 30, the communications transmitter 32 and the GPS tracker 42. In one arrangement, the central microprocessor 28 can include a timer. The central microprocessor 28 can be programmed to initiate selectively the operation of the other components in the fluid management probe 12 that are under its control based on predetermined intervals generated by the timer.

Specifically, the central microprocessor 28 and the other components of the fluid management probe 12 can remain in a standby condition for a predetermined amount of time For purposes of the invention, a standby condition can mean a condition in which a particular component is not actively collecting, processing or transmitting data relating to the fluid being monitored. The central microprocessor 28 can be programmed such that the timer can signal the central microprocessor 28 to enter an active condition. Subsequently, the central microprocessor 28 can signal one or more of the control modules 38a, 38b, 38c or 38d (which in turn can signal one or more of their corresponding sensors 40a, 40b, 40c or 40d), the data filter 26, the A/D converter 27, the communications processor and control 30, the communications transmitter 32 and (if applicable) the GPS tracker 42 to enter an active condition as well. In contrast to a standby condition, an active condition can mean a condition in which these components are actively collecting, processing or transmitting data relating to the fluid being monitored.

Once the appropriate data is collected and sent away, the central microprocessor 28 can signal the components of the fluid management probe 12 to return to a standby condition—the central microprocessor 28 can also return to a standby condition—until the central microprocessor 28 receives another signal from the timer. As an example, the timer can signal the central microprocessor 28 to enter an active condition every sixty minutes. Of course, other suitable time intervals can be used with the invention. Selectively initiating the operation of the components of the fluid management probe 12 can extend the life of the power supply 34, which can extend the amount of time that the fluid management probe 12 can operate without human intervention.

In another arrangement, the central microprocessor 28 and the other components in the fluid management probe 12 can enter an active condition based on a signal from the monitoring station 16 through the central communications station 14, both of which are shown in FIGS. 1 and 2. Such a process can occur if a user wishes to obtain instantaneously information about the fluid that the fluid management probe 12 is monitoring. This procedure can eliminate the delay present between the predetermined time intervals and can provide a user with real-time measurements.

To further conserve the power supply 34, the timer of the central microprocessor 28 can limit the amount of time that the components of the fluid management probe 12 are in an active condition. For example, once the timer signals the central microprocessor 28 to enter an active condition (which signals the other components to do the same), the timer could signal the central microprocessor 28 to return to the standby condition after a predetermined interval. Subsequently, the central microprocessor 28 and the other components of the fluid management probe 12 can return to the standby condition. This return to the standby condition can be independent of the quality of the data collected. For example, if the laser sensor 40c was having trouble obtaining a reading, the laser sensor 40c and the other components of the fluid management probe 12 would not be required to remain in the active condition until the laser sensor 40c did indeed acquire a satisfactory measurement.

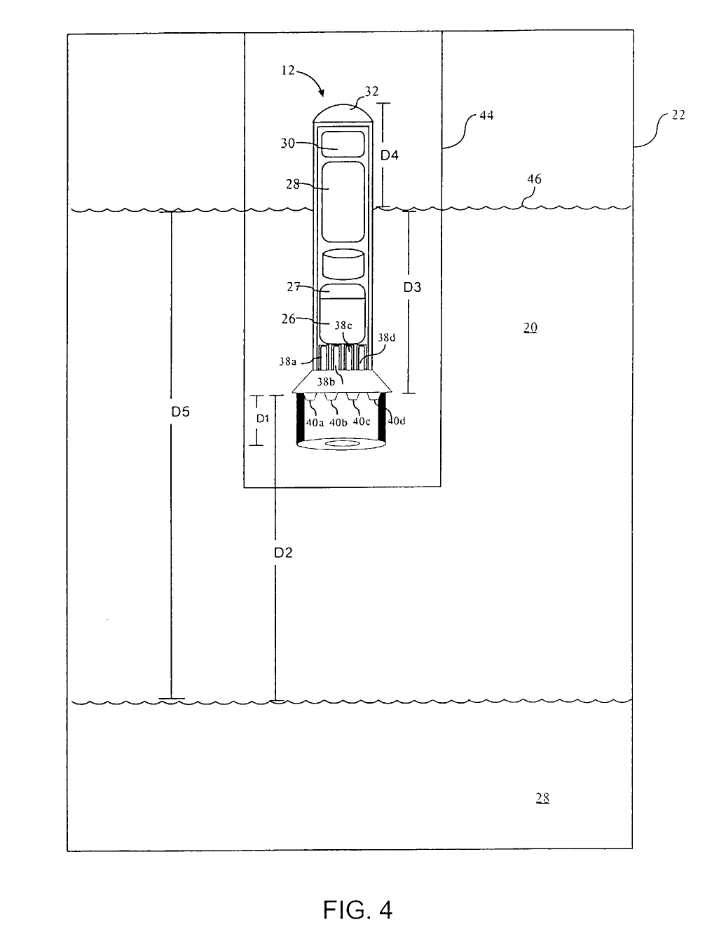

Referring to FIG. 4, the fluid management probe 12 is shown positioned inside the tank 22 of FIG. 1 in which the probe 12 is managing a fluid 20. A layer of a second fluid 28 is located at the bottom of the tank 28. The second fluid 28 can be either a contaminant or a fluid that is intended to be in the tank 22. The arrangement pictured in FIG. 4 is merely intended as an example for purposes of illustrating the operation of the fluid management probe 12, and it is understood that the invention is not limited to this particular model.

In one arrangement, the tank 22 can have a fill pipe 44, and the fluid management probe 12 can be inserted in the tank 22 through the fill pipe 44. If the fluid management probe 12 is wirelessly transmitting data that it collects such that the probe 12 IS unencumbered by any data transmission lines, then no alterations to the fill pipe 44 or any other section of the tank 22 are required to insert the probe 12 in the tank 22.

Once the fluid management probe 12 is placed in the tank 22, the probe 12 can undergo a calibration procedure. Once calibrated, the fluid management probe 12 can perform any number of measurement procedures. A measurement procedure can be any procedure in which any of the sensors 40 included in the fluid management probe 12, including sensors 40a, 40b, 40c and 40d, collect data relating to the fluid being monitored.

During the calibration procedure, ultrasound control module 38b (after receiving a signal from the central microprocessor 28) can signal the ultrasound sensor 40b to transmit one or more ultrasonic waves through the fluid 20. The ultrasound control module 38b can include a timer that notes the time at which each ultrasonic wave leaves the ultrasound sensor 40b. Once the transmitted ultrasonic waves strike the calibration ring 18, at least a portion of the ultrasonic waves will be reflected back to the ultrasound sensor 40b as interface reflections. In one arrangement, the calibration ring 18 can be positioned a predetermined distance D, from the ultrasound sensor 40b.

The timer in the ultrasound control module 38b records the time at which the ultrasound sensor 40b captures the interface reflection from the calibration ring 18. The time it takes from transmission of a particular ultrasonic wave until the time that the ultrasound sensor 40b receives the wave's reflection from the calibration ring 18 can be referred to as a calibration cycle time. This definition of calibration cycle time is not limited to ultrasonic waves, as any other form of energy that can create a reflection such that a portion of the energy is returned to a receiver—including a laser pulse—can be employed to generate a calibration cycle time.

The ultrasound control module 38b can send the interface reflection signal from the calibration ring 18 and the calibration cycle time to the data filter 26. As the data filter 26 has been programmed to recognize and accept this particular interface reflection signal during a calibration procedure, the data filter 26 can permit the signal and the calibration cycle time, also referred to as collected data, to pass through to its A/D converter 27. The A/D converter 27 can digitize the collected data and can transfer it to the central microprocessor 28. It is understood that the term collected data is not specific to the ultrasound sensor 40b, as collected data can mean any data collected by any sensor 40 contained within the fluid management probe 12 Because ultrasonic waves travel at different speeds through different fluids, the specific density of a particular fluid can be calculated based on the amount of time it takes an ultrasonic wave to travel through the fluid. Thus, based on the calibration cycle time and the predetermined distance D₁, the central microprocessor 28 can calculate the specific density of the fluid 20. In addition, the central microprocessor 28 can use the calibration cycle time associated with the fluid 20 and the predetermined distance D₁ to calculate the depth of the fluid 20 during subsequent ultrasonic transmissions. That is, the calibration cycle time and the predetermined distance D1 can generate a depth proportion, which the central microprocessor 28 can use to calculate the depth of fluid 20 based on the amount of time it takes ultrasonic transmissions to return to the ultrasound sensor 40b.

The laser sensor 40c can also be used during the calibration procedure under a similar principle. Specifically, the laser control module 38c (after receiving a signal from the central microprocessor 28) can signal the laser sensor 40c to emit a laser pulse towards the calibration ring 18. In one arrangement, the wavelength of the laser can be approximately 650 nanometers. Those of ordinary skill in the art, however, will appreciate that other suitable laser wavelengths can be practiced with the invention. The laser sensor 40c can receive the reflection of the laser pulse from the calibration ring 18, and a timer in the laser control module 38c can generate a calibration cycle time. The predetermined distance D₁ and the calibration cycle time can be used to calculate the specific density of the fluid 20 and a depth proportion for the fluid 20, which the central microprocessor 28 can employ to calculate the depth of the fluid 20.

Once calibrated, the fluid management probe 12 can begin to collect data relating to the fluid 20. The following example illustrates how the fluid management probe 12 can measure the depth of the fluid 20. In this example, the fluid 20 can be a petroleum-based fluid, and the second fluid 28 can be a layer of water at the bottom of the tank 22. In accordance with a predetermined interval or a user initiated request, the central microprocessor 28 can signal the temperature control module 38a and the ultrasound control module 38b. The temperature control module 38a can signal the temperature sensor 40a to determine the temperature of the fluid 20, and the ultrasound control module 38b can signal the ultrasound sensor 40b to transmit one or more ultrasonic waves through the fluid 20.

The temperature sensor 40a can determine the temperature of the fluid 20, and the A/D converter 27 can digitize this data and forward it to the central microprocessor 28. Meanwhile, the ultrasound sensor 40b can transmit one or more ultrasonic waves through the fluid 20 and can capture the interface reflections of these waves. In this example, the ultrasound sensor 40b can receive interface reflections from the interface between the fluid 20 and the second fluid (water) 28 and the interface between the second fluid 28 and the bottom of the tank 22. The ultrasound sensor 40b can also receive other interface reflections such as those from the interface created from the calibration ring 18 and the interface between the fluid 20 and the sides of the fill pipe 44.

The timer in the ultrasound control module 38b can generate a measurement cycle time for each of the ultrasonic transmissions. For purposes of the invention, a measurement cycle time can mean the time from the ultrasound sensor's 40b transmission of a particular ultrasonic wave to the time the sensor 40b receives a reflection of that transmission. Of course, this definition applies to other forms of energy such as a laser pulse. The ultrasound control module 38b can transmit the interface reflection signals created from the numerous interfaces in the tank 22 and their corresponding measurement cycle times to the data filter 26.

As an example, the data filter 26 can ignore the interface reflection signals created from the calibration ring 18, as the fluid management probe 12 is no longer in the calibration stage. Moreover, if it is desirable to only determine the volume of the fluid 20 in the tank 22, the interface reflection signals created from the interface between the second fluid 28 and the bottom of the tank 22 in addition to the reflection signals produced from the interface between the fluid 20 and the sides of the fill pipe 44 can be rejected as well. In addition to these recognizable interface reflection signals, the data filter 26 can reject interface reflection signals that it cannot identify, such as those signals that would be induced from an interface between the fluid 20 and a foreign object in the fluid 20.

To determine the volume of fluid 20, however, the data filter 26 can accept the interface reflection signal created from the interface between the fluid 20 and the second fluid 28 (as noted earlier, the data filter 26 can be programmed to recognize such a signal). The A/D converter 27 can digitize the signal, and the data filter 26 can send the signal as well as the measurement cycle time to the central microprocessor 28. Subsequently, the central microprocessor 28, based on the depth proportion provided during the calibration cycle and the measurement cycle time, can calculate the depth of the fluid, or the length of the distance D₂.

As shown in FIG. 4, the fluid management probe 12 can be substantially buoyant such that at least a first portion of the probe 12 can rest above a surface 46 of the fluid 20 and at least a second portion of the probe 12 can rest below the surface 46 of the fluid 20. Constructing the fluid management probe 12 such that is substantially buoyant in the fluid 20 can permit the sensors 40a, 40b, 40c and 40d to remain in contact with the fluid 20 at all times. In particular, this design can increase the performance of the ultrasound sensor 40b, as those of ordinary skill in the art understand that the accuracy of ultrasound is increased when performed below the surface of a fluid.

In addition, having a second portion of the fluid management probe 12 positioned above the surface 46 of the fluid 20 can increase the performance of the communications transmitter 32, particularly if the fluid management probe 12 is wirelessly transmitting data collected by the probe 12. For example, if the fluid 20 is gasoline and above the surface 46 of the fluid 20 is an air/gasoline vapor mix, the RF signals are less attenuated when they travel through the air/vapor mix than through the gasoline, which makes it more efficient to transmit the RF signals above the surface of the gasoline.

To obtain accurate measurements, however, the fluid management probe 12 should consider the amount of fluid 20 above the sensors 40a, 40b, 40c and 40d up to the surface 46 of the fluid 20. This distance is labeled as a distance D₃. The distance D₃ can vary, as the densities of different fluids 20 can be very different, which may affect the amount or length of the fluid management probe 12 that rests above the surface 46. In one arrangement, the overall weight and length of the fluid management probe 12 can be programmed into the central microprocessor 28. Once the specific density of the fluid 20 is calculated during the calibration cycle, the central microprocessor 28 can determine the portion of the fluid management probe 12 that will rest above the surface 46 of the fluid 20, or a distance D₄. After the distance D₄ is calculated, the central microprocessor 28 can subtract the distance D₄ from the overall length of the fluid management probe 12 to ascertain the distance D₃. Thus, to determine the overall depth of fluid 20—a distance D₅, the central microprocessor 28 can add the distance D, to the distance D₃.

It is understood that the invention is not limited to this particular example in calculating the distance D₃, as any other suitable technique can be used for this purpose. Also, if desired, the fluid management probe 12 can also measure the depth of the second fluid 28, or any other separate fluid in the tank 22, in accordance with the above discussion.

In addition to the ultrasound sensor 40b, the fluid management probe 12 can employ the laser sensor 40c to determine the depth of a fluid in the tank 22. In particular, the laser sensor 40c is effective in helping determine the depth of clear or substantially clear fluids. As an example, if the tank 22 contained a substantially clear fluid such as gasoline, the laser sensor 40c can emit a laser pulse towards the bottom of the tank 22. The laser pulse can strike the bottom of the tank 22 and can reflect back towards the laser sensor 40c. The laser sensor 40c can capture the reflection, and similar to the fluid management probe's 12 ultrasound feature, the laser reflection can be tagged with a measurement cycle time.

The laser control module 38c can forward the data concerning the measurement cycle time to the A/D converter 27, where the data can be digitized and sent to the central microprocessor 28. The central microprocessor 28 can determine the depth of the gasoline based on the calibration proportion previously calculated and the measurement cycle time.

The fluid management probe 12 can also conduct a materials analysis of the fluid 20 during the measurement cycle. In accordance with the predetermined interval, the central microprocessor 28 can signal the materials control module 38d, which in turn can signal the materials sensor 40d to perform a materials analysis of the fluid. Once the materials sensor 40d executes its analysis, the collected data is sent to the materials control module 38d, which forwards the collected data to the data filter 26. The A/D converter 27 of the data filter 26 can digitize the signal, and the data filter 26 can send the digitized data to the central microprocessor 28.

After the central microprocessor 28 collects and processes the data provided by the sensors 40a, 40b, 40c or 40d, the central microprocessor 28 can attach the unique identifier to the collected data (if applicable) and can transfer the collected data to the communications processor and control 30. The communications processor and control 30 processes the collected data for transmission, and the communications transmitter 32 transmits the collected data. Following the transmission of the data, the central microprocessor 28 can instruct the components of the fluid management probe 12 to return to a standby condition, at least until it is time for the fluid management probe 12 to conduct another measurement cycle.

It must be noted that the foregoing example discussed in relation to FIG. 4 is merely one example of a calibration cycle and a measurement cycle and the processing of the collected data. Those of ordinary skill in the art will appreciate that the invention is not limited to this particular example, as any suitable parameter of any suitable fluid can be monitored, collected and processed in accordance with the inventive arrangements.

Referring to FIG. 1, the central communications station 14 can receive the collected data from the fluid management probe 12 and can transmit the collected data to the monitoring station 16. As noted earlier, the monitoring station 16 can process the data that it receives from the central communications station 14 and can create reports on the fluid being monitored. As an example, the monitoring station 16 can insert the depth of a particular fluid obtained by the fluid management probe 12 (through the use of the ultrasound sensor 40b or the laser sensor 40c) and can insert this depth reading into one or more volumetric equations associated with the tank storing the fluid. This calculation can determine the volume of the fluid being monitored. This process can be repeated for any number of fluids from which the fluid management probe 12 is collecting data.

If the temperature of the fluid was part of the collected data transmitted to the monitoring station 16, the monitoring station 16 can normalize the volumetric measurement that it obtains to a sixty degree Fahrenheit reading. This normalization procedure can be carried out because the measured temperature and the measured volume of the fluid can form a normalizing proportion that can be used to determine the volume of the fluid if its temperature was sixty degrees Fahrenheit. Additionally, the monitoring station 16 can provide a report concerning the fluid management probe's 12 materials analysis, which can provide details as to possible biological or chemical contamination.

Although the present invention has been described in conjunction with the embodiments disclosed herein, it should be understood that the foregoing description is intended to Illustrate and not limit the scope of the invention as defined by the claims.

What is claimed is:

1. A fluid management system, comprising:
a central communications station; and
at least one probe having at least one sensor;
wherein said sensor measures a level of a fluid and detects contaminants,
wherein said probe contains circuitry for transmitting data collected by said sensor to said central communications station.

2. The fluid management system according to claim 1, wherein said probe has a plurality of said sensors;
wherein at least one of said sensors measures the level of the fluid and another said sensor detects contaminants in the fluid.

3. The fluid management system according to claim 1, wherein said probe has a plurality of said sensors;
wherein at least one of said sensors measures the level of a first fluid and another said sensor detects contaminants in a second fluid;
wherein said probe is interchangeable between the first fluid and the second fluid.

4. The fluid management system according to claim 1, wherein said probe is substantially buoyant such that at least a first portion of said probe rests above a surface of the fluid and at least a second portion of said probe rests below the surface of the fluid.

5. The fluid management system according to claim 1, wherein said probe has a plurality of said sensors;
wherein at least one of said sensors is a temperature sensor for measuring the temperature of the fluid.

6. The fluid management system according to claim 1, wherein said sensor used to measure the level of the fluid and to detect contaminants is an ultrasound sensor.

7. The fluid management system according to claim 2, wherein said sensor used to measure the level of the fluid is a laser sensor.

8. The fluid management system according to claim 1, wherein said probe contains circuitry for wirelessly transmitting data collected by said sensor to said central communications station.

9. The fluid management system according to claim 1, wherein said probe has a unique identifier for enabling said central communications station to identify said probe.

10. The fluid management system according to claim 1, further comprising
a monitoring station; and
a communications device;
wherein said central communications station transmits said data received from said probe to said monitoring station;
wherein said monitoring station stores said data and transmits said data to said communications device.

11. The fluid management system according to claim 1, wherein the fluid is a petroleum-based fluid and at least one of the contaminants is water;
wherein the fluid is stored in a tank having a fill pipe and said probe is inserted in said tank through said fill pipe.

12. The fluid management system according to claim 1, wherein said sensor measures the level of the fluid and detects contaminants and said probe transmits said data in accordance with a predetermined interval.

13. The fluid management system according to claim 1, wherein at least a portion of the contaminants is in the fluid.

14. The fluid management system according to claim 1, wherein at least a portion of the contaminants is proximate to the fluid.

15. A fluid management system, comprising:
a central communications station; and
at least one substantially buoyant probe having at least one sensor for measuring a level of a fluid;
wherein at least a first portion of said probe rests above a surface of the fluid and at least a second portion of said probe rests below the surface of the fluid;
wherein said probe contains circuitry for wirelessly transmitting data collected by said sensor to said central communications station.

16. The fluid management system according to claim 15, wherein said sensor used to measure the level of the fluid is an ultrasound sensor.

17. The fluid management system according to claim 15, wherein said probe has a unique identifier for enabling said central communications station to identify said probe.

18. The fluid management system according to claim 15, further comprising
a monitoring station; and
a communications device;
wherein said central communications station transmits said data received from said probe to said monitoring station;
wherein said monitoring station stores said data and transmits said data to said communications device.

19. The fluid management system according to claim 15, wherein the fluid is a petroleum-based fluid;
wherein the fluid is stored in a tank having a fill pipe and said probe is inserted in said tank through said fill pipe.

20. The fluid management system according to claim 15, wherein said sensor measures the level of the fluid and said probe transmits said data in accordance with a predetermined interval.

21. A method for managing at least one fluid, comprising the steps of:
providing at least one probe having at least one sensor, measuring a level of the fluid with the sensor;
detecting contaminants with the sensor; and
transmitting from the probe data collected by the sensor to a central communications station.

22. The method according to claim 21, wherein the probe has a plurality of sensors;
wherein said method further comprises the steps of.
measuring the level of the fluid with at least one of the sensors; and
detecting contaminants in the fluid with another sensor.

23. The method according to claim 21, wherein the probe has a plurality of sensors, wherein said method further comprises the steps of:
measuring the level of a first fluid with at least one of the sensors; and
detecting contaminants in a second fluid with another sensor;
wherein the probe is interchangeable between the first fluid and the second fluid.

24. The method according to claim 21, wherein the probe is substantially buoyant and said method further comprises the step of positioning the probe such that at least a first portion of the probe rests above a surface of the fluid and at least a second portion of the probe rests below the surface of the fluid.

25. The method according to claim 21, wherein said transmitting step further comprises wirelessly transmitting from the probe data collected by the sensor to the central communications station.

26. The method according to claim 21, further comprising the steps of:
providing a monitoring station and a communications device;
transmitting from the central communications station the data received from the probe to the monitoring station;
storing the data in the monitoring station; and
transmitting the data from the monitoring station to the communications device.

27. The method according to claim 21, wherein the fluid is stored in a tank having a fill pipe and said method further comprises the step of inserting the probe in the tank through the fill pipe.

28. The method according to claim 21, further comprising the step of performing said measuring, detecting and transmitting steps in accordance with a predetermined interval.

29. The method according to claim 21, further comprising the steps of:
assigning a unique identifier to the probe; and
transmitting the unique identifier during said transmitting step.

30. A method of managing a fluid, comprising the steps of:
providing at least one probe having at least one sensor;
measuring a level of a fluid with the sensor;
positioning the probe such that at least a portion of the probe rests above a surface of the fluid and at least a portion of the probe rests below the surface of the fluid; and
wirelessly transmitting from the probe data collected by the sensor to a central communications station.

31. The method according to claim 30, wherein said transmitting step further comprises wirelessly transmitting from the probe data collected by the sensor to the central communications station.

32. The method according to claim 30, further comprising the steps of:
providing a monitoring station and a communications device;
transmitting from the central communications station the data received from the probe to the monitoring station;
storing the data in the monitoring station; and
transmitting the data from the monitoring station to the communications device.

33. The method according to claim 30, wherein the fluid is stored in a tank having a fill pipe and said method further comprises the step of inserting the probe in the tank through the fill pipe.

34. The method according to claim 30, further comprising the step of performing said measuring and transmitting steps in accordance with a predetermined interval.

35. The method according to claim 30, further comprising the steps of:
assigning a unique identifier to the probe; and
transmitting the unique identifier during said transmitting step.
